(19) United States
(12) Patent Application Publication
(10) Pub. No.: US 2017/0009944 A1
(43) Pub. Date: Jan. 12, 2017

(54) OPTICAL DEVICE INCLUDING REMOTE DOWNCONVERTER

(71) Applicant: 3M INNOVATIVE PROPERTIES COMPANY, Saint Paul, MN (US)

(72) Inventors: John A. Wheatley, Lake Elmo, MN (US); Gilles J. Benoit, Minneapolis, MN (US)

(21) Appl. No.: 15/121,156

(22) PCT Filed: Feb. 16, 2015
(86) PCT No.: PCT/US2015/016021

§ 371 Date: Aug. 24, 2016

Related U.S. Application Data
(60) Provisional application No. 61/943,791, filed on Feb. 24, 2014.

(51) Int. Cl. F21K 9/64; F21V 7/00; F21V 13/04

(52) U.S. Cl. CPC F21K 9/64; F21V 13/04; F21V 7/0033; F21Y 2115/10

(57) ABSTRACT

Luminaires (100, 200, 300, 400, 500) are disclosed. More particularly, luminaires including one or more light sources (110, 210, 310, 410, 510) configured to generate light at substantially a first wavelength are disclosed. The luminaires may include a transflector (130, 230, 330, 430, 530) and a distributed area downconverter layer. The disclosed luminaires may appear substantially color neutral when viewed in ambient light.

### BACKGROUND

Optical devices include displays and luminaires. Certain optical devices utilize downconverting elements to at least partially convert light from a light source generating a first pump wavelength to a second, longer wavelength. When the optical device is in an off state, these downconverting elements may have a yellow appearance in ambient light. Moreover, these downconverting elements may also have poor useful lifetimes when exposed to the heat generated by the pump light sources.

### SUMMARY

In one aspect, the present description relates to a luminaire. In particular, the luminaire includes one or more light sources configured to generate light at substantially a first wavelength, a transflector having a diffuse reflectivity component, and a distributed area downconverter layer. The distributed area downconverter layer is disposed adjacent the transflector, yet spaced apart from the one or more light sources, the downconverter layer being configured to downconvert at least a portion of the light from the first wavelength to a second wavelength, where the second wavelength is longer than the first wavelength.

In another aspect, the present description relates to a luminaire. The luminaire includes one or more light sources configured to generate light at substantially a first wavelength, a transflector, and a distributed area downconverter layer disposed adjacent the transflector, yet spaced apart from the one or more light sources, the downconverter layer being configured to downconvert at least a portion of the light from the first wavelength to a second wavelength, where the second wavelength is longer than the first wavelength. The transflector and the downconverter layer each include one or more curved portions. In some embodiments, the transflector and the downconverter layer each are entirely curved. In some embodiments, the transflector and the downconverter layer together form a substantially annular shape. In some embodiments, the luminaire defines a side surface of a cylinder or a cylindric section.

In some embodiments, the luminaire may include a back reflector, the back reflector disposed such that the downconverter layer is disposed between the transflector and the back reflector. In some embodiments, the luminaire may include a lightguide, the lightguide being disposed between the downconverter layer and the back reflector. In some embodiments, the luminaire may include a lightguide, the lightguide being adjacent to the downconverter layer. The back reflector may be a specular reflector or it may be a semispecular reflector. The back reflector may have a hemispheric reflectivity across the visible spectrum of at least 98%.

In some embodiments, the transflector is a structured surface film. In some embodiments, the transflector is a partial mirror film. In some embodiments, the downconverter layer includes a phosphor material. In some embodiments, the downconverter layer includes quantum dots.

In some embodiments, the transflector has a hemispheric reflectivity across the visible spectrum of at least 30%, 40%, 50%, 60%, 70%, 80%, or 90%. In some embodiments, when the luminaire is in an off state and illuminated with D65 ambient light, light reflected off the luminaire has a color difference from the ambient light of not more than 10 JND, 8 JND, 5 JND, 3 JND, 2 JND, or 1 JND. In some embodiments, when the luminaire is in an off state and illuminated with D65 ambient light, light reflected off the luminaire has a color temperature difference from the ambient light of not more than 1,000 K, 800 K, 400 K, 300 K, 200 K, or 100 K. In some embodiments, the first wavelength is substantially blue or ultraviolet. In some embodiments, the second wavelength is substantially yellow.

### BRIEF DESCRIPTION OF THE DRAWINGS

FIG. 1 is a side elevation cross-section of an exemplary optical device including a remote downconverter.

FIG. 2 is a side elevation cross-section illustrating optics of the optical device of FIG. 1 in an on state.

FIG. 3 is a side elevation cross-section illustrating optics of the optical device of FIG. 1 in an off state.

FIG. 4 is a top plan view of a luminaire including a remote downconverter.

FIG. 5 is a side elevation cross-section view of another exemplary optical device.

### DETAILED DESCRIPTION

Certain optical devices utilize downconverting elements to tailor and provide desired color outputs. For example, while light that appears white may be produced by the combination of red, blue, and green light emitting diodes (LEDs), it may be more cost effective to utilize LEDs that emit blue or ultraviolet light in combination with a downconverting element, such as a yellow phosphor. The blue light is at least partially converted into longer wavelength light. More precisely, the blue light is absorbed and reemitted as light of longer wavelengths, which collectively can appear as yellow or orange light. Complementary colors (such as blue and yellow) together produce light with a white appearance.

Distributed area downconverters are popular design choices in luminaires because they facilitate physical separation between the phosphor or downconverting element and the heat from the light sources, including the generation of light and, more generally, drive electronics. In this sense, these distributed area downconverters may be also described as remote downconverters. Additionally, physical separation of the phosphor or downconverting element from the light source can reduce incident light flux and thereby be beneficial to reducing photodegradation of the phosphor or downconverting element. Thus, downconverting elements which may develop defects or degrade in quality from exposure to extreme temperatures may have increased useful lifespans when configured as remote downconverting elements. Phosphors and other downconverting elements, however, may produce white light in an on state—that is, when provided with pump light of particular wavelengths, yet appear discolored or have an unattractive hue in an off state. For example, a light bulb or luminaire utilizing a Cerium(III)-doped yttrium aluminum garnet (Ce:YAG) phosphor will appear yellowish or orange under ambient light, if the phosphor is, for example, distributed over the entire illumination surface of the luminaire or light bulb. This may be problematic for manufacturers because the yellow appearance in the off state may be aesthetically objectionable by consumers, and it also may create confusion for the consumers because they may assume that if the lighting product appears yellow when off (e.g., on the shelf in its packaging), then it will produce yellow light when on.

Including an externally visible transflector to reflect and transmit light may in many cases improve the external ambient appearance of the luminaire, light bulb, or other optical device or article. For the purposes of this application, a transflector may be defined as an optical component that partially reflects and partially transmits light. The transflector's transmittance should be high enough to support efficient extraction of light through the entire transflector, while the reflectivity of the transflector should be high enough to support light recycling when combined with a highly reflective back reflector, such as Enhanced Specular Reflector (ESR) available from 3M Company. Under this definition, an optically clear film would not be considered a transflector because the reflectivity would not be high enough to support light recycling when combined with a highly reflective back reflector. Similarly, a highly reflective multilayer optical film, such as ESR, would also not be considered a transflector, because the overall transmittance of light through the film is not high enough to support efficient extraction of light through the reflective film. Partial mirror films, microreplicated and prism films such as Brightness Enhancing Film (BEF), glare control films, or reflective polarizers such as Dual Brightness Enhancing Film (DBEF) may be considered suitable transflectors for purposes of this application.

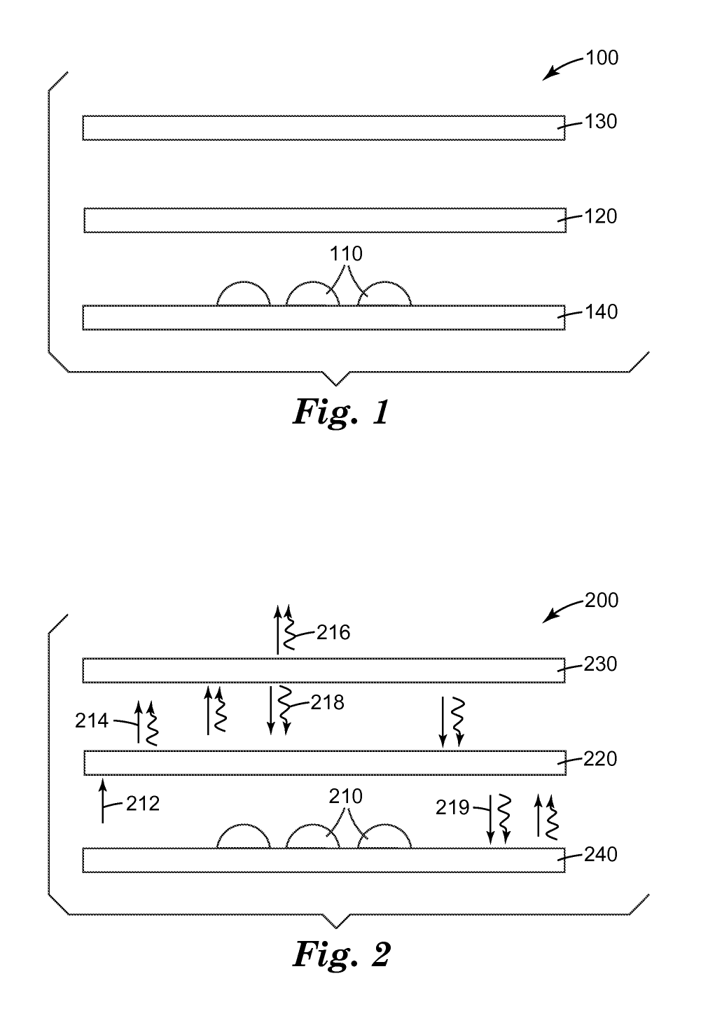

FIG. 1 is a side elevation cross-section of an exemplary optical device including a remote downconverter. Optical device 100 includes light sources 110, downconverter 120, transflector 130, and reflector 140. Optical device is illustrated in a direct-lit configuration, where light sources 110 are disposed within the areal extent of the film stack of optical device 100. Light sources 110 may be any suitable light emitting diode or combination of light emitting diodes. In some cases, light sources 110 may include one or more cold cathode fluorescent lamps (CCFLs) or even incandescent bulbs. Light source 110 may be selected to emit light at any suitable or desirable wavelength or range of wavelengths. In some embodiments, light sources 110 may emit at different wavelengths, while in other embodiments, an array of light sources 110 may emit light of substantially the same wavelength or range of wavelengths. Light sources 110 may provide any distribution of light, and may be combined with any suitable encapsulant or other optical component to provide the desired distribution of light. In some embodiments, light sources 110, especially as light emitting diodes, may emit in a substantially Lambertian distribution. Useful wavelength ranges for emitted light may include wavelengths in the blue, violet, or near-UV (UV-A) spectrum. Because downconverters will only reemit longer wavelengths of light, bluer (i.e., shorter) pump wavelengths may give more flexibility in achieving the desired output wavelength or wavelengths. Suitable drive electronics and circuitry are not shown in detail. Light sources 110 may be configurable to turn some or all of light sources 110 on at the same time. In some embodiments, light sources 110 may be dimmable, or the color temperature of the overall output light from optical device 100 may be tunable by selectively activating light sources emitting different wavelengths.

Downconverter 120 may be any suitable downconverting element. Downconverting elements have particular physical or crystalline properties which facilitate specific absorption of certain wavelengths of light. Generally, a photon or photons having a first wavelength (referred to as the pump wavelength) is absorbed by the downconverting material, leaving portions of downconverter 120 in an excited state. These portions of downconverter 120 will then spontaneously reemit less energetic photons, generally having a longer, second wavelength or range of wavelengths. The remission time may depend on the downconverting material. In many cases, not all pump light is absorbed by the downconverter 120 and some light, even light having wavelengths preferentially absorbed by the downconverting material, will pass through without being absorbed and reemitted. Thus, there is often a blending of both the downconverted light and the pump light. If these wavelengths are complements of each other (i.e., blue and yellow), then the resulting light may have a white appearance. Other color combinations are possible and within the design capability of the skilled person.

In some embodiments, downconverter 120 includes downconverting material, such as a phosphorescent or fluorescent material disposed in a polymer matrix, often an optically clear polymer. The downconverter may appear as a sheet or film and be handled as such for ease of manufacture and straightfoward assembly of optical device 100. The concentration or loading of the active downconverting material may be adjusted depending on the desired spectrum resulting from color mixing between pump and downconverted light. In some embodiments, downconverter 120 may include quantum dots: nano-scale semiconductor materials which, in effect, function as three-dimensional potential wells. These quantum dots absorb pump light and reemit photons within narrow wavelength ranges. 3M Quantum Dot Enhancement Film, or QDEF, is an example of a film including quantum dots, which may be suitable as downconverter 120 in certain embodiments. In some embodiments, the downconverter may include both phosphor elements and quantum dots.

Downconverter 120 may in some embodiments provide additional optical functionality. For example, in some embodiments, downconverter 120 may also act as a bulk or surface diffuser, which may enhance light mixing, uniformity, and provide defect hiding. In some embodiments, downconverter 120 may include a tint or pigment.

In some embodiments, downconverter 120 may not be a separate layer; instead, downconverting material may be printed, coated, or otherwise applied directly to one of the other optical elements of optical device 100, such as back reflector 140 or transflector 130.

Transflector 130 is disposed within optical device 100 such that downconverter 120 is disposed between light sources 110 and the transflector. Transflector 130 may be any suitable thickness, and may be tailored or selected to have a suitable balance between reflective and transmissive properties. Transflector 130 may have a diffuse reflectivity component. In some embodiments, transflector 130 may be tuned preferentially reflect or transmit a certain wavelength or wavelengths of light.

In many applications, the reflection properties of a film may be characterized in terms of “hemispheric reflectivity,” Rₕₑₘᵢ(λ), meaning the total reflectivity of a component (whether a surface, film, or collection of films) when light (of a certain wavelength or wavelength range of interest) is incident on it from all possible directions. Thus, the component is illuminated with light incident from all directions (and all polarization states, unless otherwise specified) within a hemisphere centered about a normal direction, and all light reflected into that same hemisphere is collected. The ratio of the total flux of the reflected light to the total flux of the incident light for the wavelength range of interest yields the hemispheric reflectivity, Rₕₑₘᵢ(λ). Characterizing a reflector in terms of its Rₕₑₘᵢ(λ) may be especially convenient for backlight recycling cavities because light is often incident on the internal surfaces of the cavity—whether the front reflector, back reflector, or side reflectors—at all angles. Further, unlike the reflectivity for normal incident light, Rₕₑₘᵢ(λ) is insensitive to, and already takes into account, the variability of reflectivity with incidence angle, which may be very significant for some components within a recycling backlight (e.g., prismatic films).

Rₕₑₘᵢ(λ) may be measured or calculated. Rₕₑₘᵢ(λ) can be measured using an apparatus described in U.S. Pat. App. Pub. No. 2013/0215512 (Coggio, et al.), incorporated by reference herein. For multilayer optical films, Rₕₑₘᵢ(λ) may also be calculated from information on the layer thickness profiles of the microlayers and the other layer elements of the optical film and from the refractive index values that are associated with each of the microlayers and other layers within the film. By using a 4×4 matrix-solving software application for the optical response of a multilayer film, both the reflection and transmission spectra can be calculated from the known layer thickness profile(s) and refractive index properties for the x-axis plane of incidence and for the y-axis plane of incidence and for each of p-polarized and s-polarized incident light. From this, Rₕₑₘᵢ(λ) may be calculated by use of the equations listed below:

$${R}_{hemi} ( λ ) = ( \frac{{R}^{x \text{-} axis} ( λ ) + {R}^{y \text{-} axis} ( λ )}{2} ) * ( 1 / {E}_{norm} )$$

$$where$$

$${R}^{x \text{-} axis} ( λ ) = \frac{1}{2} {{\int }^{π / 2}}_{0} \{ {R}_{pp - x} ( θ , λ ) + {R}_{ss - x} ( θ , λ ) \} * E ( θ ) d θ$$

$${R}^{y \text{-} axis} ( λ ) = \frac{1}{2} {{\int }^{π / 2}}_{0} \{ {R}_{ss - y} ( θ , λ ) + {R}_{pp - y} ( θ , λ ) \} * E ( θ ) d θ$$

$$and$$

$${E}_{norm} = {{\int }^{π / 2}}_{0} E ( θ ) d θ$$

where E(θ) is the intensity distribution.

Transflector 130 may have any suitable value for Rₕₑₘᵢ(λ). In some embodiments, transflector 130 may have a value of Rhemi(λ) of 30% or greater, 40% or greater, 50% or greater, 60% or greater, 70% or greater, 80% or greater, or even 90% or greater across a wavelength range of interest, for example, the visible range (depending on the application, 380-800, 390-700, 400-800, or 440-800 nm). Transflector 130 may be a structured surface film, such as those achievable through microreplication processes, or it may be a partial mirror or a reflective polarizer. Structured surfaces may include prisms, lenses, pyramids, and the like. In some embodiments, transflector 130 may be a half-silvered or partially-silvered mirror. Transflector 130 may be any combination of films or components that provide the desired reflectivity and transmission.

Reflector 140 is disposed behind light sources 110 such that reflector 140 and transflector 130 form a recycling cavity. In this configuration, reflector 140 may have very high reflectivity, which may approach 98% or 99% or more Rhemi(λ) across an extended wavelength band of interest, such as the visible range. Reflector 140 may have a diffuse component or it may be a specular reflector. In some embodiments reflector 140 has both significant diffuse and specular reflectivity components and may be referred to as a semi-specular reflector. Suitable reflectors include ESR, EDR (Enhanced Diffuse Reflector, available from 3M Company) and other highly reflective mirror films. Because of the potentially high number of bounces of light within the recycling cavity, mirror films for the reflector (and for the transflector) may desirably absorb very little light, since such absorbed light is functionally wasted. In some embodiments, because of the efficiency of recycling the light and the many passes—on average—that light makes through the downconverter, less phosphorescent or fluorescent material may be used in downconverter 120 while still providing the desired color for the emitted light.

Optical device 100 may have any suitable overall size and shape, and need not be planar. Optical device 100 may be curved or be partially curved (i.e., include curved portions). The components of optical device 100 may be adhered to one another via optically clear or optically functional (e.g., diffusing) adhesives or they may be spaced apart by one or more air gaps. Design choices of the light emitting diodes and the downconverting element, plus the inclusion on any other suitable optical element or elements may provide a desired overall emission spectrum, such as, for example, providing a visible spectrum without blue wavelengths between about 460 and 480 nm which suppress melatonin and may make sleeping difficult. Any suitable optical element or non-optical element (such as a rigid clear polymer for stability or structure) may be included within the optical device.

FIG. 2 is a side elevation cross-section illustrating optics of the optical device of FIG. 1 in an on state. Optical device 200 includes light sources 210, downconverter 220, transflector 230, and reflector 240. FIG. 2 illustrates the general operational optical principles of FIG. 1, and therefore the components labeled for FIG. 2 correspond with their counterparts in FIG. 1. FIG. 2 depicts interactions by light emitted from light sources 210 with the other components of optical device 200 and generally progresses left to right. In other words, FIG. 2 depicts the optical device of FIG. 1 in an on state, where light sources 210 are emitting light.

Emitted ray 212 is emitted from light sources 210 and includes light having substantially a suitable pump wavelength for downconverter 220. Emitted ray 212 is incident on remote downconverter 220 and is absorbed and subsequently reemitted as downconverted light 214. The curved and straight rays roughly represent the component wavelengths of light at particular points within optical device 200. In this case, for example, downconverted light 214 includes both the longer, downconverted wavelength emitted from downconverter 220 and some residual pump light not converted. Downconverted light 214 is incident on transflector 230 and is partially transmitted as emitted light 216 and partially reflected as reflected light 218. In some embodiments, transflector 230 may be achromatic; that is, the reflectivity and transmission values are not dependent on the wavelength of incident light. In other embodiments, transflector 230 may have wavelength-dependent reflectivity and transmission values, which may selectively transmit or reflect light of a certain wavelength or range of wavelengths. Reflectivity and transmission values may also vary significantly depending on the angle of incidence of downconveted light 214 on transflector 230. Reflected light 218 is incident on downconverter 220 again and at least a portion of the pump light may be absorbed and reemitted. Recycled light 219 is incident on reflector 240, reflected, and repeats the process. Fresnel reflections from the refractive index interfaces are not shown for ease of illustration.

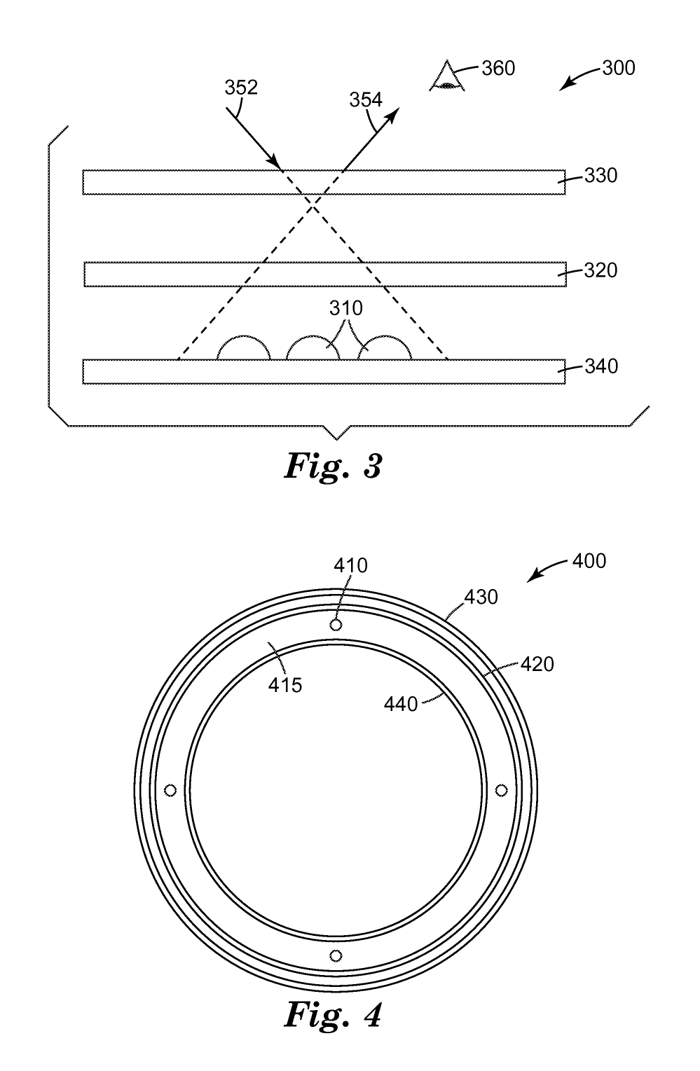

FIG. 3 is a side elevation cross-section illustrating optics of the optical device of FIG. 1 in an off state. Optical device 300 includes light sources 310, downconverter 320, transflector 330, and reflector 340. Ambient light 352 is incident on optical device 300 and reflected light 354 is observed by observer 360. The components labeled for FIG. 3 correspond with their counterparts in FIGS. 1 and 2. In an on state, the appearance of the optical device of FIGS. 1-3 are generally dominated by its emitted light. In an off state, however, an observer considering optical device 300 views the reflection of ambient light 352 the components of the optical device. Ambient light 352 is indicated with a dashed line projected into the luminaire to represent the sum of all the reflections off the components of optical device 300, as well as interaction with the downconverter (which can include reflection, absorption, and re-emission). Similarly, reflected light 354 is projected from within the luminaire as a dashed line to represent reflected light from different locations within optical device 300. For example, reflected light 354 observed by an observer 360 may include components reflected off one or more of transflector 330, downconverter 320 (including also the effects of absorption and reemission), reflector 340, or even light sources 310. Each of these components may alter the appearance of ambient light to make optical device 300 look discolored or strange. However, if the external transflector provides the dominant source of reflection for ambient light 352, then reflected light 354 may be very similar to the ambient light, providing a more neutral appearance for optical device 300 from the perspective of observer 360.

FIG. 4 is a top plan view of a luminaire including a remote downconverter. Luminaire 400 includes light sources 410, lightguide 415, downconverter 420, transflector 430, and reflector 440. Light sources 410 are provided at either the proximate or distal end of luminaire 400 and are configured to inject light into lightguide 415. Lightguide 415 may be a solid conventional lightguide, formed from a material such as acrylic, or it may be a flexible lightguide. In some cases lightguide 415 is omitted and the specularity (or semi-specularity) of the other optical components can sustain the transport of light from light sources 410 throughout the luminaire.

Light emitted from light sources 410 propagates along the lightguide and may be incident on either downconverter 420 or reflector 440. In some embodiments, luminaire 400 has no reflector 440, and light is kept within lightguide 415 by total internal reflection at the interface of the lightguide and air. Further, in embodiments without reflector 440, light incident at angles less than the critical angle (given by Snell's Law) may cross through the air at the center of luminaire 400 and reenter lightguide 415 at another point along its circumference. Transflector 430, as in FIGS. 1-3, may be a suitable prism film or partial mirror.

The overall shape of luminaire 400 may vary and the generally cylindrical shape depicted in FIG. 4 is merely exemplary. Corners, textures, patterns, varying degrees of curvature, and other interesting design features are possible, depending on both the desired light distribution profile and the aesthetic considerations of the luminaire itself.

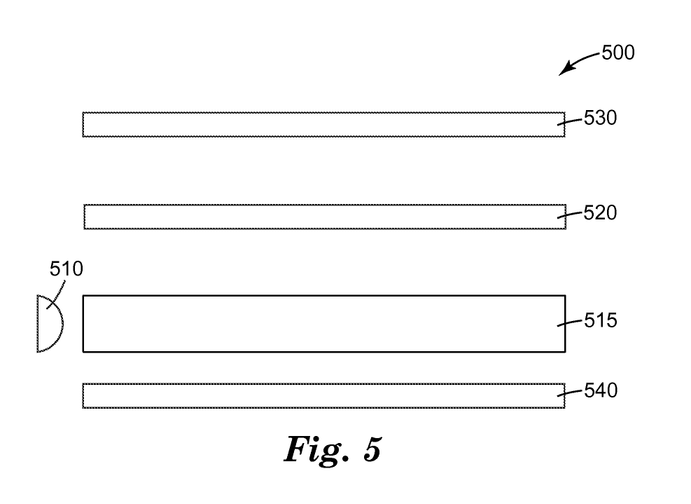

FIG. 5 is a side elevation cross-section view of another exemplary optical device. Optical device 500 includes light sources 510, lightguide 515, downconverter 520, transflector 530, and reflector 540. FIG. 5 corresponds generally to FIG. 1, except FIG. 5 is an edge-lit embodiment. Optical device 500 includes lightguide 515 and light sources 510 disposed along an edge of the lightguide. Light sources 510 inject light into lightguide 515 and it is transported down an in-plane direction of lightguide 515. Extraction features may be included on or in lightguide 515 to aid in the uniform or patternwise extraction of light.

Optical devices and luminaires described herein may be useful for a wide variety of both task and general lighting applications. Besides overhead and desk lighting, the embodiments described herein may be easily adapted to provide accent lighting, such as in automobile consoles or architectural settings to provide aesthetically interesting illumination elements. Devices may take the form of light bulbs, luminaires, signs, and task lights. In horticulture applications, where it is important to have control over the light being provided to the plants, optical devices described herein may be used. The optical devices described may also be used in illuminated signs and graphics.

All U.S. patents and patent applications cited in the present application are incorporated herein by reference as if fully set forth. Descriptions for elements in figures should be understood to apply equally to corresponding elements in other figures, unless indicated otherwise. The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

### EXAMPLES

### Example 1

A computational model of the illumination system described in FIG. 1 was prepared using MATLAB software (available from MathWorks, Natick Mass.). The back reflector (corresponding to back reflector 140 in FIG. 1) and the transflector (corresponding to transflector 130 in FIG. 1) components were characterized by hemispheric reflectivity, Rₕₑₘᵢ(λ). Calculated over a wavelength range of interest, Rₕₑₘᵢ(λ) for that wavelength range may be referred to simply as Rₕₑₘᵢ The Rₕₑₘᵢ value for the back reflector was 98% (comparable to what is available from ESR). The Rₕₑₘᵢ value of the transflector was varied from 0% (no recycling) to 90% (high recycling) in order to include a range of recycling achievable by existing films. The transflector was assumed to be achromatic, and hence had a flat spectrum.

The light source consisted of blue LEDs (110) emitting at a wavelength of approximately 445 nm and the down-converting material (120) consisted of a remote YAG phosphor sheet that exhibited a broad emission spectrum centered at approximately 550 nm. Spectra were calculated for both the light emitted by the system as well as the light reflected by the system as a function of the hemispheric reflectivity of the transflector.

The emitted spectrum was computed from the known spectra of the blue LEDs and the YAG phosphor sheet. This model of the spectrum included light from the blue LEDs that was partially converted to yellow after absorption by the down-converting material and partially transmitted through the down-converting sheet. The blue transmitted light was partially transmitted through the transflector and partially recycled, resulting in additional conversion to yellow.

The cumulative emitted spectrum was tuned by adjusting the concentration and therefore the absorption of the down-converting sheet. In this example, the concentration was adjusted to deliver a correlated color temperature as close as possible to 6,500 K. The calculation of the reflected spectrum assumed an ambient D65 standard illuminant. The model showed that, without any recycling, ambient light reflected off the down-converting sheet and was partially converted to yellow, resulting in a strong yellowish appearance. With recycling, the reflected spectrum was a combination of the ambient reflection from the transflector and of the emitted spectrum that resulted from ambient light coupling in the cavity. As the front reflection increased, the color difference between ambient and reflected light decreased and the appearance of the system in the off state was whiter. Color difference was quantified as Delta E (DE) based on the CIE L*a*b* coordinates with a DE of 2.3 corresponding to a ‘just noticeable difference’ to the human eye (1 JND). Table 1 below summarizes the results and shows that a white (i.e. color neutral) appearance can be achieved with DE values well below 2.3 when using transflectors with Rhemi values in excess of about 65%. In this table, CCT[K] is the color temperature in degrees Kelvin, xr and yr are color coordinates for the reflected color, xt and yt are the color coordinates for the transmitted color, DE is the color difference, and JND is the just-noticeable-difference value.

TABLE 1

| | | | | Transmitted | | | |
|---|---|---|---|---|---|---|---|
| Recycling | Reflected color | | | color | | | |
| (Rₕₑₘᵢ) | CCT [K] | xr | yr | xt | yt | DE | # JND |
| 0% | 4994 | 0.315 | 0.328 | 0.350 | 0.399 | 44.6 | 19 |
| 10% | 5165 | 0.317 | 0.327 | 0.343 | 0.385 | 35.8 | 16 |
| 20% | 5354 | 0.317 | 0.327 | 0.337 | 0.372 | 28.0 | 12 |
| 30% | 5558 | 0.317 | 0.327 | 0.331 | 0.361 | 21.0 | 9 |
| 40% | 5766 | 0.317 | 0.327 | 0.326 | 0.350 | 15.1 | 7 |
| 50% | 5964 | 0.317 | 0.327 | 0.322 | 0.342 | 10.2 | 4.4 |
| 60% | 6143 | 0.317 | 0.327 | 0.319 | 0.335 | 6.4 | 2.8 |
| 70% | 6292 | 0.318 | 0.326 | 0.317 | 0.330 | 3.5 | 1.5 |
| 80% | 6403 | 0.318 | 0.326 | 0.315 | 0.327 | 1.6 | 0.7 |
| 90% | 6472 | 0.318 | 0.326 | 0.314 | 0.324 | 0.4 | 0.2 |

### Example 2

A computational model of the illumination system was prepared as in Example 1, except that the transflector was chromatic with reflectivity higher in the blue than in the rest of the visible spectrum.

Computational modeling was used to show that an achromatic transflector with average visible reflectivity of 30% delivered an ‘off’ state color difference of 21 JND from the ambient spectrum. A similar chromatic transflector with hemispheric reflectivity Rₕₑₘᵢ of 70% in the range of 380-490 nm and 12% in the range of 490-800 nm achieved a color difference of only 6 JND while maintaining an ‘on’ state white point close to D65.

Exemplary embodiments include the following:
Item 1. A luminaire, comprising:
   one or more light sources configured to generate light at substantially a first wavelength;
   a transflector having a diffuse reflectivity component; and
   a distributed area downconverter layer disposed adjacent the transflector, yet spaced apart from the one or more light sources, the downconverter layer being configured to downconvert at least a portion of the light from the first wavelength to a second wavelength, wherein the second wavelength is longer than the first wavelength.
Item 2. A luminaire, comprising:
   one or more light sources configured to generate light at substantially a first wavelength;
   a transflector; and
   a distributed area downconverter layer disposed adjacent the transflector, yet spaced apart from the one or more light sources, the downconverter layer being configured to downconvert at least a portion of the light from the first wavelength to a second wavelength, wherein the second wavelength is longer than the first wavelength;
   wherein the transflector and the downconverter layer each include one or more curved portions.
Item 3. The luminaire of item 2, wherein the transflector and the downconverter layer each are entirely curved.
Item 4. The luminaire of item 2, wherein the transflector and the downconverter layer together form a substantially annular shape.
Item 5. The luminaire of item 2, wherein the luminaire defines a side surface of a cylinder or a cylindric section.
Item 6. The luminaire of items 1 or 2, further comprising a back reflector, the back reflector disposed such that the downconverter layer is disposed between the transflector and the back reflector.
Item 7. The luminaire of item 6, further comprising a lightguide, the lightguide disposed such that the lightguide is disposed between the downconverter layer and the back reflector.
Item 8. The luminaire of items 1 or 2, further comprising a lightguide, the lightguide disposed such that the lightguide adjacent to the downconverter layer.
Item 9. The luminaire of item 6, wherein the back reflector is a specular reflector.
Item 10. The luminaire of item 6, wherein the back reflector is a semispecular reflector.
Item 11. The luminaire of item 6, wherein the back reflector has a hemispheric reflectivity across the visible spectrum of at least 98%.
Item 12. The luminaire of items 1 or 2, wherein the transflector is a structured surface film.
Item 13. The luminaire of items 1 or 2, wherein the transflector is a partial mirror film.
Item 14. The luminaire of items 1 or 2, wherein the downconverter layer includes a phosphor material.
Item 15. The luminaire of items 1 or 2, wherein the downconverter layer includes quantum dots.
Item 16. The luminaire of items 1 or 2, wherein the transflector has a hemispheric reflectivity across the visible spectrum of at least 30%.
Item 17. The luminaire of items 1 or 2, wherein the transflector has a hemispheric reflectivity across the visible spectrum of at least 40%.
Item 18. The luminaire of items 1 or 2, wherein the transflector has a hemispheric reflectivity across the visible spectrum of at least 50%.
Item 19. The luminaire of items 1 or 2, wherein the transflector has a hemispheric reflectivity across the visible spectrum of at least 60%.
Item 20. The luminaire of items 1 or 2, wherein the transflector has a hemispheric reflectivity across the visible spectrum of at least 70%.
Item 21. The luminaire of items 1 or 2, wherein the transflector has a hemispheric reflectivity across the visible spectrum of at least 80%.
Item 22. The luminaire of items 1 or 2, wherein the transflector has a hemispheric reflectivity across the visible spectrum of at least 90%.
Item 23. The luminaire of items 1 or 2, wherein in an off state and illuminated with D65 ambient light, light reflecting off the luminaire has a color difference from the ambient light of not more than 10 JND.
Item 24. The luminaire of items 1 or 2, wherein in an off state and illuminated with D65 ambient light, light reflecting off the luminaire has a color difference from the ambient light of not more than 8 JND.
Item 25. The luminaire of items 1 or 2, wherein in an off state and illuminated with D65 ambient light, light reflecting off the luminaire has a color difference from the ambient light of not more than 5 JND.
Item 26. The luminaire of items 1 or 2, wherein in an off state and illuminated with D65 ambient light, light reflecting off the luminaire has a color difference from the ambient light of not more than 3 JND.
Item 27. The luminaire of items 1 or 2, wherein in an off state and illuminated with D65 ambient light, light reflecting off the luminaire has a color difference from the ambient light of not more than 2 JND.
Item 28. The luminaire of items 1 or 2, wherein in an off state and illuminated with D65 ambient light, light reflecting off the luminaire has a color difference from the ambient light of not more than 1 JND.
Item 29. The luminaire of items 1 or 2, wherein in an off state and illuminated with D65 ambient light, light reflecting off the luminaire has a color temperature difference from the ambient light of not more than 1,000 K.
Item 30. The luminaire of items 1 or 2, wherein in an off state and illuminated with D65 ambient light, light reflecting off the luminaire has a color temperature difference from the ambient light of not more than 800 K.
Item 31. The luminaire of items 1 or 2, wherein in an off state and illuminated with D65 ambient light, light reflecting off the luminaire has a color temperature difference from the ambient light of not more than 400 K.
Item 32. The luminaire of items 1 or 2, wherein in an off state and illuminated with D65 ambient light, light reflecting off the luminaire has a color temperature difference from the ambient light of not more than 300 K.
Item 33. The luminaire of claim 1 or 2, wherein in an off state and illuminated with D65 ambient light, light reflecting off the luminaire has a color temperature difference from the ambient light of not more than 200K.
Item 34. The luminaire of items 1 or 2, wherein in an off state and illuminated with D65 ambient light, light reflecting off the luminaire has a color temperature difference from the ambient light of not more than 100 K.
Item 35. The luminaire of items 1 or 2, wherein the first wavelength is substantially blue.
Item 36. The luminaire of items 1 or 2, wherein the first wavelength is substantially ultraviolet.
Item 37. The luminaire of items 1 or 2, wherein the second wavelength is substantially yellow.

1. A luminaire, comprising:
one or more light sources configured to generate light at substantially a first wavelength;
a transflector having a diffuse reflectivity component; and
a distributed area downconverter layer disposed adjacent the transflector, yet spaced apart from the one or more light sources, the downconverter layer being configured to downconvert at least a portion of the light from the first wavelength to a second wavelength, wherein the second wavelength is longer than the first wavelength.

2. A luminaire, comprising:
one or more light sources configured to generate light at substantially a first wavelength;
a transflector; and
a distributed area downconverter layer disposed adjacent the transflector, yet spaced apart from the one or more light sources, the downconverter layer being configured to downconvert at least a portion of the light from the first wavelength to a second wavelength, wherein the second wavelength is longer than the first wavelength;
wherein the transflector and the downconverter layer each include one or more curved portions.

3. The luminaire of claim 2, wherein the transflector and the downconverter layer each are entirely curved.

4. The luminaire of claim 2, wherein the transflector and the downconverter layer together form a substantially annular shape.

5. The luminaire of claim 2, further comprising a back reflector, the back reflector disposed such that the downconverter layer is disposed between the transflector and the back reflector.

6. The luminaire of claim 5, further comprising a lightguide, the lightguide disposed such that the lightguide is disposed between the downconverter layer and the back reflector.

7. The luminaire of claim 2, further comprising a lightguide, the lightguide disposed such that the lightguide adjacent to the downconverter layer.

8. The luminaire of claim 5, wherein the back reflector has a hemispheric reflectivity across the visible spectrum of at least 98%.

9. The luminaire of claim 2, wherein the transflector is a structured surface film.

10. The luminaire of claim 2, wherein the transflector is a partial mirror film.

11. The luminaire of claim 2, wherein the downconverter layer includes a phosphor material.

12. The luminaire of claim 2, wherein the downconverter layer includes quantum dots.

13. The luminaire of claim 2, wherein the transflector has a hemispheric reflectivity across the visible spectrum of at least 30%.

14. The luminaire of claim 2, wherein in an off state and illuminated with D65 ambient light, light reflecting off the luminaire has a color difference from the ambient light of not more than 10 JND.

15. The luminaire of claim 2, wherein in an off state and illuminated with D65 ambient light, light reflecting off the luminaire has a color temperature difference from the ambient light of not more than 1,000 K.
